(19) United States
(12) Patent Application Publication
(10) Pub. No.: US 2018/0225270 A1
(43) Pub. Date: Aug. 9, 2018

(54) PROCESSING USER ACTION IN DATA INTEGRATION TOOLS

(71) Applicant: INTERNATIONAL BUSINESS MACHINES CORPORATION, Armonk, NY (US)

(72) Inventors: Manish A. Bhide, Hyderabad (IN); Jo A. Ramos, Grapevine, TX (US)

(21) Appl. No.: 15/425,151

(22) Filed: Feb. 6, 2017

(51) Int. Cl. G06F 17/22; G06F 17/24; G06F 17/21; G06F 9/44

(52) U.S. Cl. CPC G06F 17/2282; G06F 9/4443; G06F 17/212; G06F 17/246

(57) ABSTRACT

User-inferred data integration actions within tabular data. A user action with respect to a first portion of tabular data is detected. Examples of user action include a deletion, addition and/or modification in a row, column, cell or a combination thereof. The data integration tool may determine if the user action is a recognized action or a learned action, based on at least one type of the user action and at least one characteristic of the first portion of the tabular data. Suggests to the user an option to replay the recognized action or the learned action on a second portion of the tabular data, wherein the first portion and the second portion have at least one common characteristic. If the user action is neither a recognized action nor a learned action, the data integration tool suggests to the user an option to learn, or store, the user action in memory.

### BACKGROUND

The present invention generally relates to data processing tools, and more particularly tools for processing user actions on tabular data.

Existing data integration tools are very complex to use. They require highly skilled users; they are batch oriented and cater to Information Technology (“IT”) users. In recent years, new data preparation tools have emerged. They purport to be intuitive, interactive, and provide self-service capabilities. These tools cater to less skilled users such as business or citizen analysts. However, these new tools still use a similar paradigm as the traditional data integration tools. The main problem with the approach taken by all of these tools is that the user has to identify what they want to do in a set of user actions that the tool supports. Most tools support more than 100 user actions, thus allowing the user to find the right user action for a specific task can become very complex.

### SUMMARY

Embodiments of the present invention disclose a method, a computer program product, and a system for user-inferred data integration actions within tabular data. In one embodiment, a method for processing user actions on tabular data may comprise detecting a user action on a first portion of the tabular data having a certain characteristic, wherein the user action comprises a deletion, addition and/or modification in a row, column, cell or any combination thereof. Next, the data integration tool may determine if the user action is a recognized action or a learned action, wherein the determining is based on at least one type of the user action and at least one characteristic of the first portion of the tabular data, and either suggesting to the user an option to replay the recognized action or the learned action on a second portion of the tabular data, wherein the first portion and the second portion have at least one common characteristic, or suggesting to the user an option to learn the user action in memory if the user action is neither a recognized action nor a learned action.

In another embodiment, a method for processing user actions on tabular data may comprise a deletion or a filtration and wherein the determining is based on a characteristic of the first portion of the tabular data which may include a null value or an empty value, and suggesting to the user an option to delete or filter the second portion of the tabular data, wherein the second portion of the tabular data includes a corresponding characteristic of the first portion of the tabular data, including at least one null value or empty value.

In another embodiment, a method for processing user actions on tabular data may comprise a deletion or filtration and wherein the determining is based on a characteristic of the first portion of the tabular data which may include at least one outlier value, and suggesting to the user an option to delete or filter the second portion of the tabular data, wherein the second portion of the tabular data includes a corresponding characteristic of the first portion of the tabular data, including at least one outlier value.

In another embodiment, a method for processing user actions on tabular data may comprise an addition and wherein the determining is based on a characteristic of the first portion of the tabular data which may include a data pattern, and suggesting to the user an option to perform the addition on the second portion of the tabular data, wherein the second portion of the tabular data includes the data pattern of the first portion of the tabular data.

In another embodiment, a method for processing user actions on tabular data may comprise a modification, and wherein the determining is based on a characteristic of the first portion of the tabular data which may include a data pattern, and suggesting to the user an option to modify the second portion of the tabular data, wherein the second portion of the tabular data includes the data pattern of the first portion of the tabular data.

In another embodiment, a method for processing user actions on tabular data may comprise a deletion, addition and/or modification in a row, column, cell or any combination thereof.

In another embodiment, a method for processing user actions on tabular data may comprise a deletion, addition and/or modification in a row, column, cell or any combination thereof, wherein determining that a characteristic of the first portion of the tabular data includes at least one outlier value, comprises comparing the value of a cell in the first portion of the tabular data to at least two other cells in either the same row or the same column, and determining that the characteristic of the first portion of the tabular data includes at least one outlier value based on the comparison.

In another embodiment, a method for processing user actions on tabular data wherein a characteristic of a given cell value comprises a format of the cell value, and wherein comparing the value of a cell in the first portion of the tabular data to at least two other cells in either the same row or the same column, may comprise multiple steps. One step compares the format of the value of the cell in the first portion of the tabular data with the format of other cells in the same row and the same column as the cell. Another step may comprise selecting for comparison, to determine outlier values, either the row or the column having cells, other than a column header or a row identifier, whose format matches the format of the cell in the first portion of the tabular data. Another step may comprise comparing the value of the cell in the first portion of the tabular data to the values of cells in the row or column selected for comparison.

In another embodiment, a computer program product for processing user actions on tabular data may comprise a non-transitory tangible storage device having program code embodied therewith, the program code executable by a processor of a computer to perform a method, the method may comprise detecting, by the processor, a user action on a first portion of the tabular data having a certain characteristic. The data integration tool may determine, by the processor, if the user action and the characteristic of the first portion of the tabular data is a recognized action or a learned action, and either suggesting, by the processor, to the user an option to replay the recognized action or the learned action on a second portion of the tabular data, wherein the first portion and the second portion of the tabular data have at least one common characteristic, or suggesting, by the processor, to the user an option to learn the user action in memory if the user action is neither a recognized action nor a learned action.

In another embodiment, a computer system may comprise one or more computer devices each having one or more processors and one or more tangible storage devices, and a program embodied on at least one of the one or more storage devices, the program having a plurality of program instructions for execution by the one or more processors, wherein the program instructions comprise instructions to detect a user action on a first portion of the tabular data having a certain characteristic. The computer system may determine if the user action and the characteristic of the first portion of the tabular data is a recognized action or a learned action, and either suggesting to the user an option to replay the recognized action or the learned action on a second portion of the tabular data, wherein the first portion and the second portion of the tabular data have at least one common characteristic, or suggesting to the user an option to learn the user action in memory if the user action is neither a recognized action nor a learned action.

### BRIEF DESCRIPTION OF THE SEVERAL VIEWS OF THE DRAWING

The following detailed description, given by way of example and not intended to limit the invention solely thereto, will best be appreciated in conjunction with the accompanying drawings in which not all structures may be shown.

FIG. 1 is a block diagram which illustrates the computing environment that contains spreadsheet program, in accordance with an embodiment of the present invention.

FIG. 2 is a flowchart illustrating specific operational steps of spreadsheet program, in accordance with an embodiment of the present invention.

FIG. 3 is a spreadsheet depicting hypothetical tabular data arranged with column labels and its corresponding dataset arranged with flip-flopped column labels as row labels.

FIG. 4 is a block diagram depicting the hardware components of the computing environment executing spreadsheet program, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Embodiments of the invention provide a new approach for processing user actions performed on tabular data and address shortcomings of the prior art. Under this new approach, embodiments of the invention enable a data tabulation tool, such as a spreadsheet program, to recognize or learn user interactions within a first portion of tabular data, store said actions in a spreadsheet memory and prompt the user to repeat said action(s) within a second portion of tabular data.

Embodiments of the invention may infer user intention based on a previous user action on a first portion of the tabular data values and suggests, or prompts, previously recognized, stored, or learned actions on a second portion of the tabular data.

An embodiment may include a method to delete null or empty value(s) throughout the tabular data set as a whole. The method may include querying user to learn, or store, in memory the performed user action of deleting a null or empty value(s) within a first portion of the tabular data and subsequently prompting user to perform said learned, or stored, user action on a second portion of the tabular data, which may include the entirety of the tabular data set as a whole.

Another embodiment may include a method to add or edit value(s) throughout the tabular data set as a whole. The method may include the recognition of a user input from a pre-programmed database and subsequently prompt user to input said recognized, or stored, value on a second portion of the tabular data, which may include the entirety of the tabular data set as a whole. The method may also include querying user to learn, or store, in memory a user action, for example adding or editing value(s) within a first portion of tabular data, and subsequently prompting user to perform said learned, or stored, user action from memory on a second portion of the tabular data.

Another embodiment includes a computer program product for integrating and storing data values within a tabular data set. The computer program product may include a computer readable storage medium having program instructions embodied therewith. The computer readable storage medium is not a transitory signal per se. The program instructions may be executable by a processor to cause a computer to perform a method. The method may include running a spreadsheet program or another document tabulation program on a computing device which may include querying a user to learn, or store, in memory the performed user action on a first portion of the tabular data, for example deleting null or empty value(s) within the tabular data set. Said spreadsheet program on said computing device subsequently prompts user to perform said learned, or stored, user action on a second portion of the tabular data set.

Another embodiment includes running a spreadsheet program on a computing device which may include a method to add or edit value(s) throughout the tabular data set as a whole. Said spreadsheet program on said computing device may include recognizing a user input from the stored pre-programmed database within said spreadsheet program on a first portion of the tabular data, and subsequently prompting user to input said recognized, or stored, value on a second portion of the tabular data set. The spreadsheet program contained within the computing device may also include a method of querying user to learn, or store, in memory the performed user action of adding or editing value(s) within a first set of the tabular data and subsequently prompting user to perform said learned, or stored, user action from memory on a second portion of the tabular data.

Detailed embodiments of structures and methods are disclosed herein; however, it can be understood that the disclosed embodiments are merely illustrative of structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art.

Embodiments of the present invention will now be described in detail with reference to the accompanying figures. The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a first portion of tabular data” or “a second portion to tabular data” may include reference to one or more rows, columns or cells contained within the tabular data unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for integrating recognized user actions or learned user actions (i.e. deletions, additions, or modifications) within a first portion of the tabular data, and applying such recognized or learned user actions to a second portion of the tabular data. The invention will be described according to its overview components and the flow of its user actions.

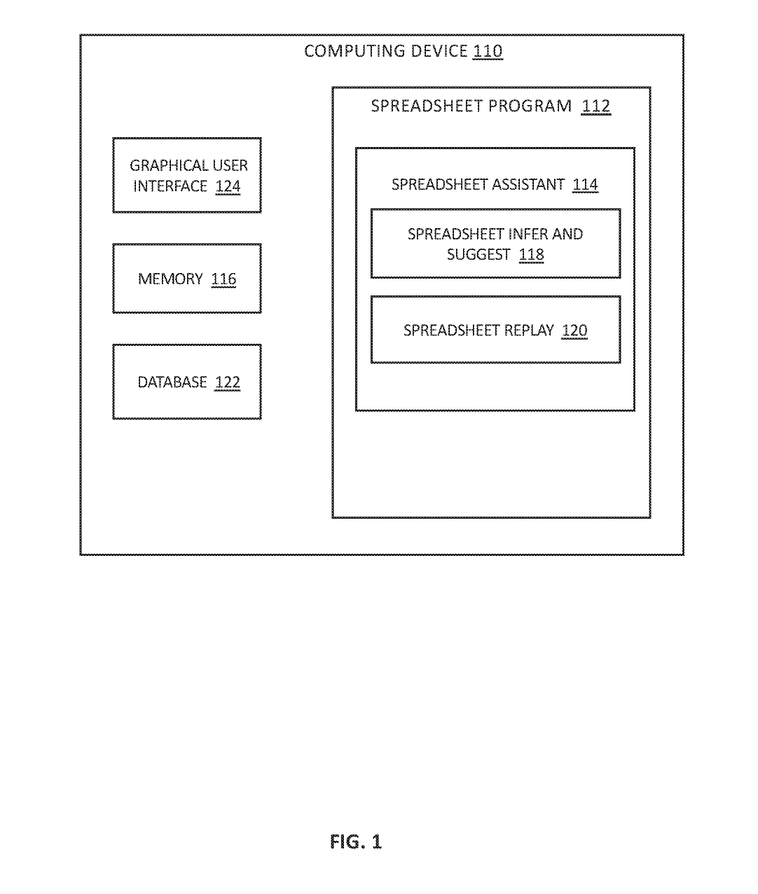

FIG. 1 illustrates computing device 110, which represents a computing device that comprises a graphical user interface 124, a memory 116, and a database 122. Spreadsheet program 112 operates within computing device 110, in accordance with an embodiment of the invention, and comprises spreadsheet assistant 114. Spreadsheet assistant 114 further comprises spreadsheet infer and suggest 118, and spreadsheet replay 120.

In the example embodiment, spreadsheet program 112 is the intermediary that receives input from computing device 110 and sends output to spreadsheet assistant 114. Spreadsheet assistant 114 receives input, or instructions, from spreadsheet program 112 and directs, or sends, output to spreadsheet infer and suggest 118 and/or spreadsheet replay 120.

Spreadsheet infer and suggest 118 and spreadsheet replay 120 may share input and output information in order to accomplish a specific task on the tabular data, as more fully described herein.

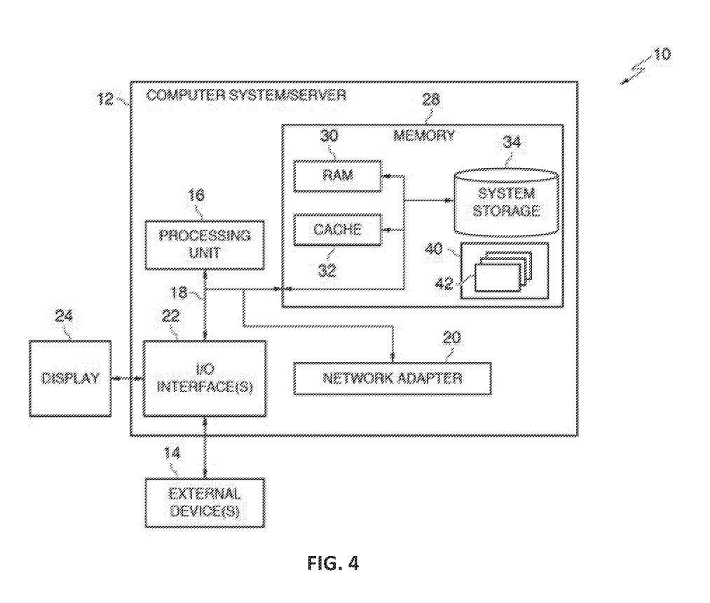

Computing device 110 may be any type of computing device that is capable of connecting to a network, for example, a laptop computer, tablet computer, netbook computer, personal computer (PC), a desktop computer, a personal digital assistant (PDA), a smart phone, or any programmable electronic device or computing system or server supporting the functionality required by one or more embodiments of the invention. The computing device 110 may include internal and external hardware components, as described in further detail below with respect to FIG. 4. In other embodiments, computing device 110 may operate in a cloud computing environment. While computing device 110 is shown as a single device, in other embodiments, computing device 110 may be comprised of a cluster or plurality of computing devices, working together or working separately.

Graphical user interface 124 may be any type of application that is run on computing device 110, for example, the application can be a web application, a graphical application, an editing application or any other type of application/program that allows a user to upload, change, delete, alter, or update data to computing device 110.

Memory 116 may be a data bank that stores learned tabular data manipulations (i.e. within row(s), column(s), and/or cell(s), or any combination thereof) at user's discretion. Memory 116 may include a magnetic disk storage device of an internal hard drive, compact disc read-only memory (CD-ROM), digital versatile disk (DVD), memory stick, magnetic tape, magnetic disk, optical disk, a semiconductor storage device such as random access memory (RAM), read-only memory (ROM), erasable programmable read-only memory (EPROM), flash memory or any other computer-readable tangible storage device that can store a computer program and digital information.

Database 122 may be an information archive located within computing device 110 and may be comprised of pre-programmed formatting rules (E.g. state names and their respective two letter abbreviations, and common measurement conversions are just two examples). Database 122 is not limited to pre-programmed formatting rules. A user may store specific rules within database 122 that are specifically tailored to a user's dataset. For example, user may store names (including first and last name) of employees within database 122 so that when user begins to enter an employee's name within the tabular data, spreadsheet assistant 114 may infer the employee's full name after a few letters of the employee's name is entered, and suggest to user to input the inferred name.

Spreadsheet program 112 is an organized operating environment on computing device 110 which may allow a user to interface with tabular data via graphical user interface 124. Spreadsheet assistant 114 is a function of spreadsheet program 112, and comprises spreadsheet infer and suggest 118, and spreadsheet replay 120. These various functions may assist spreadsheet program 112 interface with a user in order to perform tabular data manipulations (i.e. specific formatting for addresses or dates, or deletion of null/empty or outlier values, are just two such examples), as will be further exemplified herein.

Spreadsheet infer and suggest 118 may be implemented as a feature of spreadsheet assistant 114 which analyzes user-data interactions on a first portion of the tabular data and prompts user to either replay learned actions stored in memory 116 or insert recognized actions stored in database 122.

A first portion of the tabular data may include a user selected row, column or cell or any combination thereof that the user manipulates. User manipulations may include deletions, additions, modifications, edits, or any combination thereof. A second portion of the tabular data is the corresponding portion of data that is being manipulated in conjunction with the recognized action or learned action on the first portion of the tabular data. A second portion of the tabular data may be a row, column, or cell or any combination thereof.

A first portion of the tabular data may comprise various characteristics that are subject to user manipulations. Said characteristics may include, but are not limited to, a specific value or a specific format. For example, a particular cell may comprise a specific value (i.e. a number, a word, a null value, an empty value, or an outlier value are just some examples) or a specific format style (i.e. state abbreviation (“NY”) or U.S. currency by inclusion of a “$”). These characteristics will be explained in more detail via illustrated and written examples herein.

In the example embodiment, when a user begins to manipulate data on a first portion of the tabular data that was previously learned and stored in memory 116 or recognized in database 122, spreadsheet infer and suggest 118 suggests to user to replay said learned or recognized action for the current task. For example, user may delete a row that contains null/empty value(s) and when prompted by spreadsheet program 112 to learn the user-data manipulation, user enters a rule that instructs spreadsheet assistant 114 to identify null/empty values contained within a row in a first portion of the tabular data, or to a more restricted second portion of the tabular data, and then to delete such row(s) that contain null/empty values. This new instruction, or rule, is stored in memory 116. The next time a user enters a null/empty value into a first portion of the tabular data, spreadsheet infer and suggest 118 prompts user to apply the new rule previously stored in memory 116.

Spreadsheet replay 120 is another feature of spreadsheet assistant 114 that analyzes a second portion of the tabular data and applies either the retrieved learned action stored in memory 116 or the recognized action stored in database 122, as received from spreadsheet infer and suggest 118, to an applicable second portion of the tabular data. An applicable second portion of the tabular data will include similar characteristics, which may comprise data value(s) (i.e. a null/empty value corresponding to a common column/row is just one example) or format (i.e. abbreviated state name (“NY”) versus state name spelled out (“New York”) is just one example).

For example, if a user accepts the suggestion to apply a learned action to a second portion of the tabular data, then spreadsheet replay 120 analyzes the second portion of the tabular data to locate any instances of shared characteristics to apply the command from spreadsheet infer and suggest 118, and carries out the suggestion. As such, spreadsheet replay 120 works together with spreadsheet infer and suggest 118 to carry out the commands on applicable second portion(s) of the tabular data.

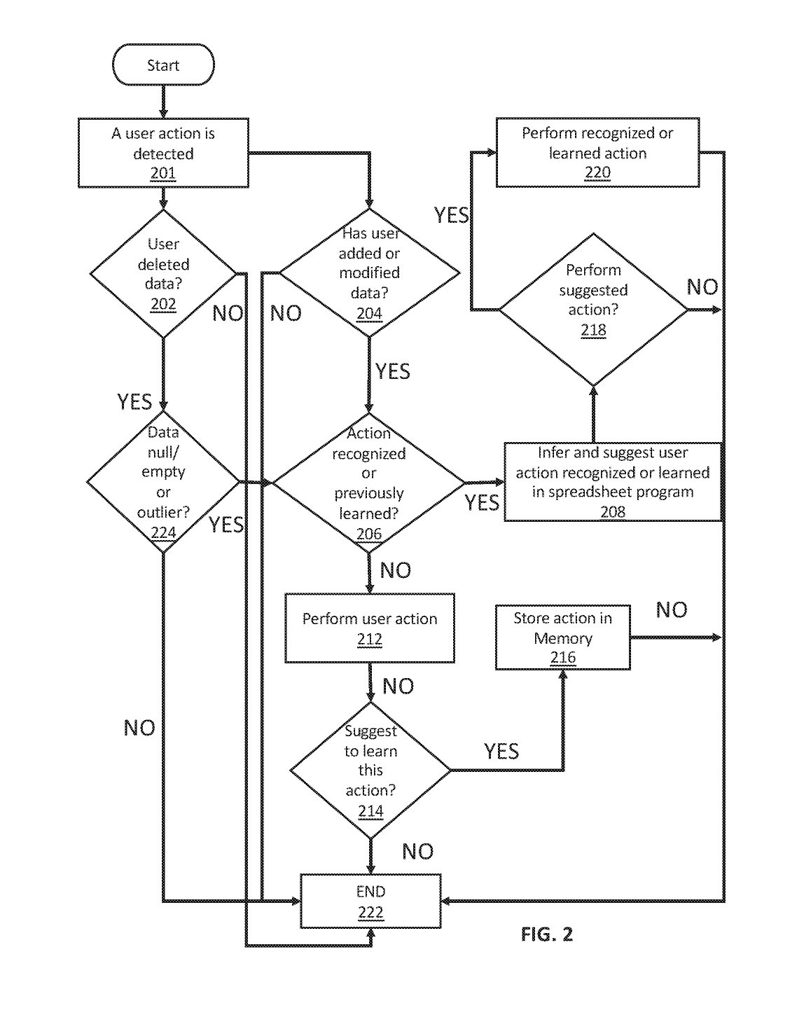

FIG. 2 is a flowchart depicting operational steps performed by a spreadsheet program in accordance with an embodiment of the present invention. These operational steps may be implemented using program instructions that are executable by a computer processor. In one embodiment, the spreadsheet program may be spreadsheet program 112 of computing device 110 as depicted in FIG. 1.

Referring now to FIGS. 1 and 2, spreadsheet program 112 detects a user action on a first portion of the tabular data (step 201). If the user has added or edited data (decision step 204 “YES” branch), then spreadsheet assistant 114 scans database 122 and memory 116 to determine whether the user action is a recognized action or previously learned action (decision step 206). If the user action is recognized or previously learned (decision step 206 “YES” branch), then spreadsheet assistant 114 cues spreadsheet infer and suggest 118 to query user to infer and suggest a data manipulation on a corresponding second portion of the tabular data (step 208). If the user directs spreadsheet assistant 114 to perform the recognized or previously learned data manipulation on a corresponding second portion of the tabular data (decision step 218 “YES” branch), then spreadsheet replay 120 scans the remaining portions, or a user delineated second portion, of the tabular data and applies the first portion tabular data manipulation to a corresponding second portion of the tabular data (step 220). If the user does not direct spreadsheet assistant 114 to perform the recognized or previously learned data manipulation to a corresponding second portion of the tabular data (decision step 218 “NO” branch), then no further action is taken (step 222).

For example, consider a computer spreadsheet dataset that contains customer data. The various columns in the dataset may include the following headings: Customer Name, Customer Address, Customer Type, Customer Email, Customer Phone Number. In one of the rows within the Customer Address column, the address may be entered as: 123 Anything Drive NY. The user may add commas to the aforementioned address and change it to: 123, Anything Drive, NY. If this data manipulation was not previously learned or recognized by spreadsheet assistant 114, then spreadsheet infer and suggest 118 may ask user to standardize the Customer Address column to a second portion of the tabular data (i.e. the corresponding rows, columns, and/or cells within the tabular data where this formatting change would apply). If the user says yes to the query, spreadsheet replay 120 may scan the remaining portions of the dataset and apply the manipulation of the first portion of the tabular data to a corresponding second portion of the tabular data (i.e. the corresponding rows, columns, and/or cells within the tabular data) and, in this case, standardizes said column into the following format: street number, street name, state.

If the user action is neither recognized in database 122 nor previously learned in memory 116 (decision step 206 “NO” branch), then user performs the tabular data manipulation, either addition or modification (step 212). After the user performs the aforementioned tabular data manipulation, spreadsheet assistant 114 suggests to user to learn said action (decision step 214). If the user selects to learn, or store, said action (decision step 214 “YES” branch), same is stored in memory 116 (step 216). If the user does not select to learn, or store, said action (decision step 214 “NO” branch) in memory 116, then no further action is taken (step 222).

For example, consider a small business' sales data spreadsheet wherein the column headings are: Name of State, Sales Amount, Sales Date, and Return Amount. The Sales Amount and Return Amount columns do not have a “$” in it and it is recognized as a column containing number values. The user may go to one row in either the Sales Amount and Return Amount column and add a “$” in front of the number value in the cell (i.e. 13,333 to $13,333) (step 212). Spreadsheet assistant 114 may recognize the “$” in database 122 as being the sign for U.S. currency and then prompt user to change the data type to U.S. currency in the column that contains the “$” by suggesting to add a “$” in all rows for the same column. If the user accepts the suggested action, then the action will be stored in memory 116 (decision step 214 “YES” branch) and all future values entered in said row of said column will contain the “$” before the numerical value.

In another example, user may have a dataset that contains U.S. state names across a row or a column (i.e. California, New York, Arizona, Vermont). Database 122 may be pre-programmed by user to include the names of all U.S. states and their corresponding two letter abbreviations. If user edits a particular cell from a state name to a state abbreviation (i.e. “California” to “CA”) (step 204) then spreadsheet assistant 114 recognizes this edit in database 122 (decision step 206 “YES” branch).

Spreadsheet infer and suggest 118 then suggests to user to convert the state names to their respective two letter abbreviations across the row or column within the dataset (step 208). If user selects to perform the suggested action (decision step 218 “YES” branch), then spreadsheet replay 120 will convert the state names to their corresponding two letter abbreviations, as found in database 122, across the row or column within the dataset (step 220). If user selects not to perform the suggested action (decision step 218 “NO” branch), then no further action will be taken.

In another embodiment of this invention, spreadsheet program 112 detects a user action on a first portion of tabular data (step 201). The user has deleted data (decision step 202 “YES” branch) and spreadsheet assistant 114 asks user whether the deleted data contains a null or empty value or an outlier (decision step 224).

In statistics, an outlier is a data point that significantly differs from the other data points in a sample. As such, an outlier may be identified as a value that “lies outside” (e.g. value is at least one standard deviation more or less than the mean values within a selected set of data) most of the other values in a set of data. For example, in a set of scores: 25, 29, 3, 32, 85, 33, 27, 28 both 3 and 85 may be “outliers”.

In a sample embodiment, spreadsheet assistant 114 may identify outliers as numerical value(s) that are one standard deviation from the mean of a set of numerical values within a second portion of tabular data (i.e. row, column, cell or any combination thereof). A user is not limited to a particular formula or calculation to determine an outlier value in a dataset. The user may delineate its own criteria for determining outlier values.

There are at least two variations to locate an outlier in a dataset: (1) spreadsheet assistant 114 can traverse a row and find the outlier(s) in the row, and suggest to delete all columns that contain an outlier in that row; (2) the other variant is where spreadsheet assistant 114 can traverse a column and find the outlier(s) in that column, then suggest to delete all rows that contain an outlier in that column.

If the deleted data does contain either a null value, empty value or outlier (decision step 224 “YES” branch), then spreadsheet assistant 114 determines whether the user action is a recognized or learned action (decision step 206). If the user action is a recognized or learned action (decision step 206 “YES” branch), then spreadsheet infer and suggest 118 suggests to user to delete the null value(s), empty value(s), or outlier(s) on a second portion of the tabular data (step 208). If the user accepts the suggestion to delete the null value(s), empty value(s), or outlier(s) on a second portion of the tabular data (decision step 218 “YES” branch), then spreadsheet replay 120 deletes the null value(s), empty value(s), or outlier(s) within the applicable second portion of the tabular data (step 220). If the user does not accept the suggestion to delete the null value(s), empty value(s), or outlier(s) on a second portion of the tabular data (decision step 218 “NO” branch), then no further action is taken (step 222).

An example of this embodiment may include a spreadsheet which contains sales data for a company. The user selects one row of data and deletes it. Spreadsheet assistant 114 analyzes the data present in each cell across the deleted row (first portion of the tabular data) and identifies null value(s), empty value(s), or outlier(s) contained within said first portion of the tabular data. If the user desires to delete other cells in a second portion of the tabular data that contain the same characteristics as the deleted first portion of the tabular data, then spreadsheet assistant 114 traverses either the row or column (depending on which characteristics the user intends to delete) on a second portion of the tabular data and identifies corresponding null value(s), empty value(s), or outlier(s) to be deleted.

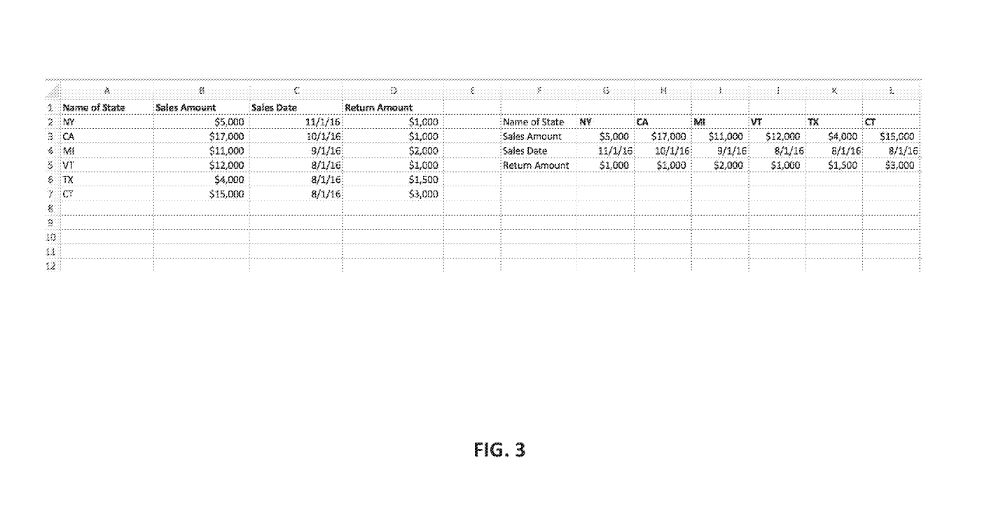

Spreadsheet infer and suggest 118 may suggest to user to delete specific cells, rows, or columns in the second portion of the tabular data that have been identified as null/empty value(s) or outlier(s). An illustrative example of the above-described sales data spreadsheet is provided in FIG. 3. As seen in FIG. 3, there are various columns labeled as follows: Name of State, Sales Amount, Sales Date, Return Amount. User selects one row of data and deletes it.

Spreadsheet assistant 114 analyzes this first portion of tabular data and identifies null values or empty values in two cells in the selected row. Next, spreadsheet assistant 114 analyzes the second portion of the tabular data (which represents the remaining cells in the dataset outside of the deleted row) and identifies corresponding null values or empty values across various other rows in the second portion of the tabular data.

Spreadsheet infer and suggest 118 may suggest to user to delete the columns in the second portion of the tabular data where the Sales Amount, for example, contains a null value or empty value. Since tabular data may be set up with interchangeable rows and column labels representing the same information (i.e. column label can similarly be set up to be a row label), spreadsheet assistant 114 may similarly analyze a column and delete null values or empty values within the corresponding row, rather than analyze a row and delete null values or empty values within the corresponding column.

If the user action is not a recognized or previously learned action (decision step 206 “NO” branch), then user performs the deletion on the first portion of the tabular data (step 212). After user performs the aforementioned deletion on the first portion of tabular data, spreadsheet assistant 114 suggests to user to learn, or store, said deleted values (i.e. outlier value(s) or null value(s) are just two such examples) and their corresponding column/row label (decision step 214).

Consider the aforementioned example wherein various columns are labeled: Name of State, Sales Amount, Sales Date, Return Amount. The user selects one row and deletes it. Spreadsheet assistant 114 analyzes the data distribution of the various columns and may determine that the Return Amount for the deleted row was at least one standard deviation more or less than the mean of the Return Amounts in the other rows in the dataset (i.e. an outlier).

In another embodiment, spreadsheet assistant 114 may analyze the distribution of sales data and determine that most of the Return Amounts are greater than $10,000, and the particular deleted row had a Return Amount less than $10,000. Spreadsheet assistant 114 may then suggest to user to apply a filter to the dataset with Return Amounts less than $10,000. This user-created filter will delete all rows where the Return Amounts of the sales are less than $10,000.

A filter, as used herein, comprises a process that removes redundant or unwanted information from a data set using computerized methods. A filter hides the redundant or unwanted information from the user, rather than deletes the information.

If the user selects to learn, or store, said filter action described above (decision step 214 “YES” branch) (i.e. in a scenario where the deleted data value(s) are outlier value(s)), same is stored in memory 116 (step 216). If the user does not select to learn, or store, its deleted data values (decision step 214 “NO” branch), then said tabular data deletion is not learned, or stored, in memory 116 (step 222).

Referring now generally to embodiments of the invention, a method for processing user actions on tabular data may perform one or more of the following functions.

According to an embodiment, the method may detect a user action on a first portion of the tabular data having a characteristic. For example, a user may be working on a spreadsheet containing tabular data such as a sales report (e.g. see FIG. 3). The spreadsheet may be displayed and manipulated through a spreadsheet program. The user may be entering data in a cell, row, column, or any combination thereof. The user may be deleting data, modifying data, hiding data, filtering data, or changing the format of data, all within a cell, a row, a column, or any combination thereof. The method may detect these actions as the user performs them. In an embodiment, the first portion of the tabular data refers to the cell, row, column or combination thereof to which the user action applies. For example, if a user deletes a row then the first portion of the tabular data includes the deleted row. A characteristic may refer to a property of the data, including but not limited to any of the following: value, size, structure, font, format, associations with other data, symbol, data type or category (e.g. general, number, currency, accounting, date, time, percentage, fraction, scientific, text, custom).

According to an embodiment, the method may determine if the user action and the characteristic of the first portion of the tabular data is a recognized action or a learned action. A recognized action may include a command, format change, spelling change, data calculation, character conversion, or any other action that may be pre-programmed into database 122. For example, a user may type a U.S. state name into a spreadsheet dataset (e.g. California, New York, Vermont) which may be a recognized action by database 122 to convert the U.S. state name to its corresponding two letter U.S. state abbreviation (e.g. CA, NY, VT). A learned action may include a user performing an action once (e.g. format, conversion, addition, deletion) and subsequently storing said action in memory 116. For example, a user may format the following address “123 Anything Dr NY” within a cell by adding commas as follows, “123, Anything Dr, NY”. The user may then store said formatting action in memory 116 as a learned action, to be performed the next time user enters a similarly formatted address into the spreadsheet.

According to an embodiment, the method may suggest to the user an option to replay the recognized action or learned action on a second portion of the tabular data, wherein the first portion and the second portion of the tabular data have at least one common characteristic. In an embodiment, the second portion of the tabular data refers to a cell, row, column or any combination thereof that comprises the same or similar characteristic as the selected first portion of the tabular data. For example, a user may select a first portion of the tabular data that contains a U.S. state name (e.g. “California”) and convert the state name to its corresponding U.S. state abbreviation (e.g. “CA”) which is a recognized action. The method may then prompt the user to replay the U.S. state name conversion to a second portion of the tabular data that contains other U.S. state names. The second portion of the tabular data that contains other U.S. state names may include an entire row, column, individual cells or any combination thereof. Similarly, a learned action may be replayed on a second portion of the tabular data that contains at least one similar characteristic as the first portion of the tabular data. For example, using the same example from the previous paragraph, a user may format the following address “123 Anything Dr. NY” to “123, Anything Dr., NY” and store said formatting action as a learned action in memory 116. The method may suggest the option to replay said learned action on a second portion of the tabular data that contains at least one common characteristic, which in this scenario would be a similarly formatted street address.

Alternatively, if the user action is neither a recognized nor a learned action, the method may suggest to learn said user action in memory 116, to be replayed on a second portion of the tabular data as a learned action. For example, the user may have a column in their spreadsheet that contains a lot of null values. The user may replace “null” with “NA” in one of the cells, make this a new learned action in memory, and now have the option to apply “NA” to a second portion of the tabular data that contains null values.

According to an embodiment, the user action includes a deletion or a filtration and the method determines that a characteristic of the first portion of the tabular data includes a null value or an empty value. A null or empty value in a cell is one that contains no value. In this case, for example, the method may suggest to the user an option to delete or filter the second portion of the tabular data, wherein the second portion of the tabular data includes a corresponding characteristic of the first portion of the tabular data, including at least one null value or empty value.

According to an embodiment, the method may suggest to the user an option to delete or filter the second portion of the tabular data, wherein the second portion of the tabular data includes a corresponding characteristic of the first portion of the tabular data, including at least one null value or empty value. For example, a user may be reviewing his sales data in a spreadsheet program and may want to filter all of the null values or empty cell values in the dataset, since they are not contributing any number value to the sales figures. The user may hide, or filter, a cell that contains a null value or empty cell value. The method may then suggest to user to hide, or filter, a second portion of the tabular data that contains null values or empty cell values. This method allows the user to hide, or filter, the empty values in his spreadsheet and focus on the data that contains actual values.

According to an embodiment, the user action includes a deletion or a filtration and the method determines that a characteristic of the first portion of the tabular data includes at least one outlier value. Referring to FIG. 3 as an example, a user may delete row 6, which includes cells B6, C6, and D6, based on the fact that cell B6 contains a sales amount of $4,000 which is a sales amount significantly less than four of the remaining five sales amounts in the column. Solely looking at Sales Amounts, Cell B6 is an outlier value because the majority of the cells in the Sales Amount column are greater than $10,000, and cell B6 is less than $10,000.

According to an embodiment, the method may suggest to the user an option to delete or filter the second portion of the tabular data, wherein the second portion of the tabular data includes a corresponding characteristic of the first portion of the tabular data, including at least one outlier value. In our example using FIG. 3, the sales amount of $4,000 is considered an outlier value in the deleted row 6, as compared to the other values in the same Sales Amount column. Another possible outlier value in a second portion of the tabular data may be cell B2, since the sales amount of $5,000 is also an amount that is less than $10,000 within the Sales Amount column. Since cell B2 includes a corresponding characteristic (sales amount) as cell B6, this is a valid comparison to make when looking for outlier values in a second portion of the tabular data.

According to an embodiment, wherein the method to determine that a characteristic of the first portion of the tabular data includes at least one outlier value may comprise comparing the value of a cell in the first portion of the tabular data to at least two other cells in either the same row or the same column. For example, in FIG. 3 a user may delete row 6, which includes cells B6, C6, and D6. Cell B6 contains a Sales Amount of $4,000; Cell C6 contains Sales Date Aug. 1, 2016; and Cell D6 contains a Return Amount of $1,500. In this scenario, the method will seek other outlier values by comparing at least two other cells in the same row as B6 as well as at least two other cells in the same column as B6. The purpose of these two comparisons is to determine comparable cell characteristics as cell B6 (the first portion of the tabular data). When traversing the other cells in the same row as B6, the method finds that there is only one other cell, D6, that contains a value with a similar characteristic as B6. Cell C6 does not contain a monetary value. Since at least two of the other cells in the same row do not correspond to a similar characteristic of the sales data, the method will compare the value of cell B6 in the first portion of the tabular data to at least two other cells in the same column as cell B6. When traversing the other cells in the same column as B6 (the first portion of the tabular data), the method finds that at least two other cells, in this case ALL of the other cells, in the column correspond to a similar characteristic as cell B6, namely Sales Amounts. As such, the method determines that it must traverse the same column, not row, as cell B6 to search for other outlier values.

According to an embodiment, wherein the method to determine that the characteristic of the first portion of the tabular data includes at least one outlier value based on the comparison. The outlier value is determined after a comparison of cells in either the same row or column, based on the characteristic of the data cells. For example, in FIG. 3, a user may select cell B6. In order to determine if cell B6 is an outlier value, it is compared to the other cell values in column B since it is determined that column B contains similar characteristic values. The other values in FIG. 3's column B include: $5,000, $17,000, $11,000, $12,000, and $15,000. The comparison of cell B6 ($4,000) to the other values in column B and determining that cell B6 is an outlier value may be as simple as the user determining that it is less than $10,000 and therefore flagged to be an outlier value. Determining whether a value is an outlier can be as sophisticated as the user desires. For example, a user may instruct the method to add up all of the cell values in the column, calculate an average and determine that any cell values that fall within two standard deviations below the average are outliers. The user may adjust its data computations to determine outliers based on criteria that the user sees fit to analyze or depict the data.

According to an embodiment, wherein a characteristic of a given cell value comprises a format of the cell value, and wherein comparing the value of a cell in the first portion of the tabular data to at least two other cells in either the same row or the same column may comprise comparing the format of the value of the cell in the first portion of the tabular data with the format of other cells in the same row and the same column as the cell. For example, in FIG. 3 we see that cell B6 contains a “$” and number values. If we compare cell B6 across the row, we find that cell C6 does not contain a “$” but rather a format as follows: number/number/number. If we continue across row 6, we find that cell D6 contains a “$” and a number value, which is the same format as cell B6. However, at least two of the cells in the row are not a consistent format and therefore the method would determine that the entire row is not a consistent format. On the other hand, if we compare cell B6 to cells B2, B3, B4, B5, and B7 we see that all of the compared cells contain a “$” and number value. The complete column is a consistent format with similar characteristics and therefore contains the proper second portion of the tabular data to compare to cell B6, the first portion of the tabular data.

According to an embodiment, wherein selecting for comparison, to determine outlier values, either the row or the column having cells, other than a column header or a row identifier, whose format matches the format of the cell in the first portion of the tabular data as described above. An example may include the tabular data of FIG. 3 that depicts the state names as the column headers and depicts Sales Amount, Sales Date, and Return Amount as the row identifiers. If a user wants to determine outlier values in its Sales Amounts, the user may select to hide the lowest sale amount value, which would be $4,000 located in cell K3. In order to compare the $4,000 sales amount value with other cell values that contain the sales amount characteristic, the method would traverse the row, and not the column in this setup, in order to find at least two other cells with similar characteristics. While traversing the row, the method would not include the row identifier (“Sales Amount”) as one of the two other cells in correlating characteristic values, since the row identifier (and column header) is merely a label and is not intended to be a part of the tabular dataset per se.

According to an embodiment, wherein the method compares the value of the cell in the first portion of the tabular data to the values of cells in the row or column selected for comparison. Once the method determines the row or column with similar characteristics as the cell in the first portion of the tabular data, it will compare the values across the row or column to the cell value in the first portion of the tabular data. For example, if a user is trying to identify and delete all cells in a row or column whose value is “Canada”, then user initially selects and deletes the cell containing “Canada”. The method will then traverse the row and column of the initial deleted cell in order to determine whether the characteristic of “Canada” is found in the row or column. Once determined, the method can go ahead and ask the user if they wish to delete all cells in a row or column whose value is “Canada”, without the user having to go through the data and delete the cell values one by one.

According to an embodiment, wherein the user action comprises an addition and wherein the method determines that a characteristic of the first portion of the tabular data includes a data pattern. A data pattern may refer to a characteristic pattern of the data in a particular cell, including but not limited to any of the following: value, size, structure, font, format, associations with other data, symbol, data type or category (e.g. general, number, currency, accounting, date, time, percentage, fraction, scientific, text, custom).

According to an embodiment, the method may suggest to the user an option to perform the addition on the second portion of the tabular data, wherein the second portion of the tabular data includes the data pattern of the first portion of the tabular data. An example may comprise the user adding multiple commas to a cell that contains an address “99 Penn Ave Calif.”, thus becoming “99, Penn Ave, Calif.”. The method may recognize that the other cell values within the same row or column contain a similar data pattern, and therefore prompt user to standardize the address row or column and separate each component of the address by inserting commas.

According to an embodiment, wherein the user action comprises a modification and wherein the method determines that a characteristic of the first portion of the tabular data includes a data pattern, and suggests to the user an option to modify the second portion of the tabular data, wherein the second portion of the tabular data includes the data pattern of the first portion of the tabular data. For example, a user may add a “$” to a cell. The method may recognize that the other cell values within the same row or column contain a data pattern, and therefore prompt user to change the type of the row or column to U.S. Dollars.

According to an embodiment, wherein the user action comprises a deletion, addition and/or modification in a row, column, cell or any combination thereof. For example, a user may include a timestamp format as a column header to notate specific times of the day corresponding to data entry in a particular cell in that column. The user may edit one of the cells in the timestamp column and delete the time format part of the cell. The method may then ask the user if they wish to delete the time format part of the column in all of the cells in the column, or ask the user to move the time format part of the column to a new column.

According to an embodiment, wherein the user action comprises a conversion of a state name to an abbreviation in a particular cell in a first portion of the tabular data and suggests to the user to convert state names to an abbreviation across all rows or all columns, or any combination thereof in a second portion of the tabular data.

According to an embodiment, wherein the user action comprises a standardization of a street address in a particular cell into a format comprising “street number, street name, and state”, in a first portion of the tabular data and suggests to the user to standardize street addresses across rows, columns, or any combination thereof, into a format comprising “street number, street name, and state”, in a second portion of the tabular data.

Referring now to FIG. 4, a schematic of an example of a computing device 10 (which may be, for example, computing device 110 of FIG. 1) is shown. Computing device 10 is only one example of a suitable computing device, and is not intended to suggest any limitation as to the scope of use or functionality of embodiments of the invention described herein. Regardless, computing device 10 is capable of being implemented and/or performing any of the functionality set forth hereinabove.

In computing device 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computing device 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for processing user actions on tabular data, comprising:
detecting a user action on a first portion of the tabular data having a characteristic;
determining if the user action and the characteristic of the first portion of the tabular data is a recognized action or a learned action; and either
suggesting to the user an option to replay the recognized action or learned action on a second portion of the tabular data, wherein the first portion and the second portion of the tabular data have at least one common characteristic; or
suggesting to the user an option to learn the user action in memory if the user action is neither a recognized action nor a learned action.

2. The method of claim 1, wherein the user action comprises a deletion or a filtration and wherein the determining comprises:
determining that a characteristic of the first portion of the tabular data includes a null value or an empty value; and
wherein the suggesting to the user an option to replay the recognized or learned action on a second portion of the tabular data comprises:
suggesting to the user an option to delete or filter the second portion of the tabular data, wherein the second portion of tabular data includes a corresponding characteristic of the first portion of the tabular data, including at least one null value or empty value.

3. The method of claim 1, wherein the user action comprises a deletion or filtration and wherein the determining comprises:
determining that a characteristic of the first portion of the tabular data includes at least one outlier value; and
wherein the suggesting to the user an option to replay the recognized or learned action on a second portion of the tabular data comprises:
suggesting to the user an option to delete or filter the second portion of the tabular data, wherein the second portion of the tabular data includes a corresponding characteristic of the first portion of the tabular data, including at least one outlier value.

4. The method of claim 1, wherein the user action comprises an addition and wherein the determining comprises:
determining that a characteristic of the first portion of the tabular data includes a data pattern; and
wherein the suggesting to the user an option to replay the recognized or learned action on a second portion of the tabular data comprises:
suggesting to the user an option to perform the addition on the second portion of the tabular data, wherein the second portion of the tabular data includes the data pattern of the first portion of the tabular data.

5. The method of claim 1, wherein the user action comprises a modification, and wherein the determining comprises:
determining that a characteristic of the first portion of the tabular data includes a data pattern; and
wherein the suggesting to the user an option to replay the recognized or learned action on a second portion of the tabular data comprises:
suggesting to the user an option to modify the second portion of the tabular data, wherein the second portion of the tabular data includes the data pattern of the first portion of the tabular data.

6. The method of claim 1, wherein the user action comprises a deletion, addition and/or modification in a row, column, cell or any combination thereof.

7. The method of claim 3, wherein determining that a characteristic of the first portion of the tabular data includes at least one outlier value, comprises:
comparing the value of a cell in the first portion of the tabular data to at least two other cells in either the same row or the same column; and
determining that the characteristic of the first portion of the tabular data includes at least one outlier value based on the comparison.

8. The method of claim 7, wherein a characteristic of a given cell value comprises a format of the cell value, and wherein comparing the value of a cell in the first portion of the tabular data to at least two other cells in either the same row or the same column, comprises:
comparing the format of the value of the cell in the first portion of the tabular data with the format of other cells in the same row and the same column as the cell;
selecting for comparison, to determine outlier values, either the row or the column having cells, other than a column header or a row identifier, whose format matches the format of the cell in the first portion of the tabular data; and
comparing the value of the cell in the first portion of the tabular data to the values of cells in the row or column selected for comparison.

9. The method of claim 6, wherein the user action comprises:
converting a state name to an abbreviation in a particular cell in a first portion of the tabular data; and
proposing to the user to convert state names to an abbreviation across all rows or all columns, or any combination thereof in a second portion of the tabular data.

10. The method of claim 6, wherein the user action comprises:
standardizing a street address in a particular cell into a format comprising “street number, street name, and state”, in a first portion of the tabular data; and
proposing to the user to standardize street addresses across rows, columns, or any combination thereof, into a format comprising “street number, street name, and state”, in a second portion of the tabular data.

11. A computer program product for processing user actions on tabular data, comprising a non-transitory tangible storage device having program code embodied therewith, the program code executable by a processor of a computer to perform a method, the method comprising:
detecting, by the processor, a user action on a first portion of the tabular data having a characteristic;
determining, by the processor, if the user action and the characteristic of the first portion of the tabular data is a recognized action or a learned action; and either suggesting, by the processor, to the user an option to replay the recognized action or learned action on a second portion of the tabular data, wherein the first portion and the second portion of the tabular data have at least one common characteristic; or
suggesting, by the processor, to the user an option to learn the user action in memory if the user action is neither a recognized action nor a learned action.

12. The computer program product of claim 11, wherein the user action comprises a deletion or a filtration and wherein the determining comprises:
determining, by the processor, that a characteristic of the first portion of the tabular data includes a null value or an empty value; and
wherein the suggesting to the user an option to replay the recognized action or learned action on a second portion of the tabular data comprises:
suggesting, by the processor, to the user an option to delete or filter the second portion of the tabular data, wherein the second portion of the tabular data includes a corresponding characteristic of the first portion of the tabular data, including at least one null value or empty value.

13. The computer program product of claim 11, wherein the user action comprises a deletion or filtration and wherein the determining comprises:
determining, by the processor, that a characteristic of the first portion of the tabular data includes at least one outlier value; and
wherein the suggesting to the user an option to replay the recognized action or learned action on a second portion of the tabular data comprises:
suggesting, by the processor, to the user an option to delete or filter the second portion of the tabular data, wherein the second portion of the tabular data includes a corresponding characteristic of the first portion of the tabular data, including at least one outlier value.

14. The computer program product of claim 11, wherein the user action comprises an addition and wherein the determining comprises:
determining, by the processor, that a characteristic of the first portion of the tabular data includes a data pattern; and
wherein the suggesting to the user an option to replay the recognized action or learned action on a second portion of the tabular data comprises:
suggesting, by the processor, to the user an option to perform the addition on the second portion of the tabular data, wherein the second portion of the tabular data includes the data pattern of the first portion of the tabular data.

15. The computer program product of claim 11, wherein the user action comprises a modification, and wherein the determining comprises:
determining, by the processor, that a characteristic of the first portion of the tabular data includes a data pattern; and
wherein the suggesting to the user an option to replay the recognized action or learned action on a second portion of the tabular data comprises:
suggesting, by the processor, to the user an option to modify the second portion of the tabular data, wherein the second portion of the tabular data includes the data pattern of the first portion of the tabular data.

16. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
detecting a user action on a first portion of the tabular data having a characteristic;
determining if the user action and the characteristic of the first portion of the tabular data is a recognized action or a learned action; and either suggesting to the user an option to replay the recognized action or learned action on a second portion of the tabular data, wherein the first portion and the second portion of the tabular data have at least one common characteristic; or
suggesting to the user an option to learn the user action in memory if the user action is neither a recognized action nor a learned action.

17. The computer system of claim 16, wherein the user action comprises a deletion or a filtration and wherein the determining comprises:
determining that a characteristic of the first portion of the tabular data includes a null value or an empty value; and
wherein the suggesting to the user an option to replay the recognized action or learned action on a second portion of the tabular data comprises:
suggesting to the user an option to delete or filter the second portion of the tabular data, wherein the second portion of the tabular data includes a corresponding characteristic of the first portion of the tabular data, including at least one null value or empty value.

18. The computer system of claim 16, wherein the user action comprises a deletion or filtration and wherein the determining comprises:
determining that a characteristic of the first portion of the tabular data includes at least one outlier value; and
wherein the suggesting to the user an option to replay the recognized action or learned action on a second portion of the tabular data comprises:
suggesting to the user an option to delete or filter the second portion of the tabular data, wherein the second portion of the tabular data includes a corresponding characteristic of the first portion of the tabular data, including at least one outlier value.

19. The computer system of claim 16, wherein the user action comprises an addition and wherein the determining comprises:
determining that a characteristic of the first portion of the tabular data includes a data pattern; and
wherein the suggesting to the user an option to replay the recognized action or learned action on a second portion of the tabular data comprises:
suggesting to the user an option to perform the addition on the second portion of the tabular data, wherein the second portion of the tabular data includes the data pattern of the first portion of the tabular data.

20. The computer system of claim 16, wherein the user action comprises a modification, and wherein the determining comprises:
determining that a characteristic of the first portion of the tabular data includes a data pattern; and
wherein the suggesting to the user an option to replay the recognized action or learned action on a second portion of the tabular data comprises:
suggesting to the user an option to modify the second portion of the tabular data, wherein the second portion of the tabular data includes the data pattern of the first portion of the tabular data.
